(19) United States
(12) Patent Application Publication
(10) Pub. No.: US 2014/0223490 A1
(43) Pub. Date: Aug. 7, 2014

(54) APPARATUS AND METHOD FOR INTUITIVE USER INTERACTION BETWEEN MULTIPLE DEVICES

(71) Applicant: SHANGHAI POWERMO INFORMATION TECH. CO. LTD., Shanghai (CN)

(72) Inventors: Qi Pan, Shanghai (CN); Wei Zhu, Shanghai (CN); Xiong-Hui Guo, Shanghai (CN)

(73) Assignee: Shanghai PowerMo Information Tech. Co. Ltd., Shanghai (CN)

(21) Appl. No.: 13/851,090

(22) Filed: Mar. 26, 2013

(30) Foreign Application Priority Data
Feb. 7, 2013 (CN) 201310049782.3

(51) Int. Cl. H04N 21/422; G06F 3/0354; H04N 21/81; H04N 21/41; H04N 21/414; H04N 21/485; G06F 3/0488; G06F 3/14

(52) U.S. Cl. CPC H04N 21/42224; G06F 3/04883; G06F 3/03547; G06F 3/1454; H04N 21/4126; H04N 21/41407; H04N 21/4858; H04N 21/8186
USPC 725/61; 345/173; 345/163

(57) ABSTRACT

Method and system for providing intuitive user interaction for sharing among multiple devices is provided, where a remote device without intuitive user interaction is connected to a local device configured with intuitive user interaction; a thumbnail control scheme in which display images of remote device screen are rendered in local device's screen and intuitive method to allow user to quickly interact with remote side application is provided; generic remote control scheme in which local device is acting as an external user interaction peripheral device of remote device is provided; and a region enhancement mode is provided by having areas pre-defined in the remote device, and having the pre-defined areas' respective layouts resized, reconfigured and mirrored in the local device, while the touch events that have occurred in the mapped areas in the local device are remapped and sent to an application that is rendered in the remote device.

### BACKGROUND OF THE INVENTION

1. Field of the Invention

The present invention relates to an apparatus and method for intuitive user interaction between multiple devices, and more particularly to a plurality of intuitive user interaction methods in which an electronic device, a remote device, without intuitive user interaction and user interface capability is connected to another electronic device, a local device, configured with user interface capability and intuitive user interaction methods for facilitating sharing therebetween.

2. Description of Related Art

In recent years, an integrated multimedia presentation or display system featuring multiple numbers of display devices being connected together has become popular among consumers. The typical usage includes of having one mobile electronic device configured with user interaction capability and an another electronic device without user interaction capability, such as the instance when one mobile phone is connected with one HDTV, in which the connection therewith can be achieved via a wired cable (i.e., such as RGB, HDMI cables) or via wireless connection (i.e., such as, WIFI display, WIDI etc).

In an usage example of the aforementioned integrated multimedia display system, one application (can be referred as an application A) can be operating in one mobile phone, while also having displayed images thereof being mirrored and rendered in a remotely connected HDTV; meanwhile, another application (can be referred as an application B) can be operated in the mobile phone and having the displayed images thereof rendered in the local screen of the mobile phone. Since typically there is no touch-based graphical user interface peripheral device or capability being equipped with the HDTV, thus, the necessity to provide user interactions with the application A becomes a problem. The usage scenarios of the aforementioned integrated multimedia display system can also include the situation of having one application (application A) operating on the HDTV (i.e. the HDTV being either a smart HDTV or a set-top box) and having the generated displayed images thereof rendered in the respective HDTV; meanwhile, another application (application B) operating in the mobile phone has the displayed images thereof being rendered in the display screen thereof.

In a situation where the application A and the application B are not operating in a same electronic device, there is a need for configuring two separate electronic devices to be operatively connected together so as to enable the exchange of relevant control information therebetween. In addition, there is another usage scenario where one application (application A) is running in one mobile device A, while having its respective display images rendered in a HDTV; meanwhile there is another application (application B) running on another mobile device B while having its respective display images rendered in the display screen thereof. In the usage scenario where the application A and the application B are not running in the same electronic device, there should be a way to have these two electronic devices connected so that the control and other information can be exchanged therebetween. As a result, there is room for improvement within the art.

### SUMMARY OF THE INVENTION

An objective of the present disclosure is to provide user interface capability to an electronic device that is without any such user interface capability through the connection to another electronic device that is configured with the user interface capability so as to form an integrated multiple-device multimedia display system featuring connected multiple multimedia electronic devices configured with displays.

Another objective of the present disclosure is to provide a set of methods for intuitive user interaction between multiple devices, and to provide a plurality of intuitive user interaction methods in which a remote device without intuitive user interaction is connected to a local device configured with intuitive user interaction methods for facilitating sharing therebetween.

To achieve the above-said objectives, the present invention provides an application to run in one electronic device, such as a local device, i.e. a mobile phone, having fully range of touch-enabled user interaction capability, while one or more multimedia or application content can be rendered in another electronic device, such as a remote device, i.e. a HDTV, a regular TV, without having full range of touch-enabled user interaction capability.

### BRIEF DESCRIPTION OF THE DRAWINGS

FIG. 1 shows a first embodiment of an implementation for invoking and dismissing a thumbnail control method in which display images are rendered in landscape orientation on a local mobile phone device.

FIG. 2 shows the first embodiment of the implementation for invoking and dismissing a thumbnail control method in which display images are rendered in landscape orientation on a local mobile phone device.

FIG. 3 shows a process flowchart of a first embodiment of an implementation for invoking and dismissing a thumbnail control method in which display images are rendered and multiple applications are run on multiple electronic devices which are connected together,

FIG. 4 shows the embodiment of the implementation of the thumbnail control window with system menu.

FIG. 5 shows coordinate transformation by linear mapping to ensure a width (X) and a height (Y) to maintain the same when re-mapped between two rectangle areas.

FIG. 6 shows a mobile phone operating under a mouse/trackpad operating mode under the generic remote control method, in which the mobile phone is turned into a mouse/trackpad device.

FIG. 7 shows the normal touch screen operation mode.

FIG. 8 shows the local device operating in a hovering mode, in which the local device includes a touch area and a hover area.

FIG. 9 shows another exemplary embodiment of the hovering mode having an isolation area.

FIG. 10 shows an example in which the hover area can also be a relatively small area in one corner of the screen of the local device.

FIG. 11 shows an embodiment of the air mode indicator method, in which there can also be various manipulations regarding the finger images displayed in the remote device.

FIGS. 12a-12b show the mirrored content in a plurality of interested designated areas from the HDTV being without layout reconfiguration; and with layout reconfiguration in the mobile phone, respectively.

FIG. 13 shows a preferred embodiment of the usage application found in the mobile phone to ease the interested area selection and layout reconfiguration.

FIG. 14 shows a generic architecture for a system for providing user interface capability to a remote device without user interface capability through connection to a local device configured with user interface capability.

FIG. 15 shows a basic software architecture of the system for providing user interface capability to a remote device without user interface capability through connection to a local device configured with user interface capability so as to form an integrated multiple-device multimedia system of a typical client-server paradigm.

FIG. 16 shows the OS application framework having capabilities for several functional modules.

FIG. 17 shows the console app containing a sink module, an input events generation module, an action zone management module, and a region enhancement management module.

### DETAILED DESCRIPTION OF EMBODIMENTS

In the embodiments as described herein, the operating system (OS) for mobile phone can be Apple iOS, Google Android, Samsung Bada, Blackberry OS, Windows Phone, Linux, etc. . . . . The operating system (OS) for smart TV or HDTV can be Google Android, Apple iOS, Linux, etc.

Thumbnail Control Method:

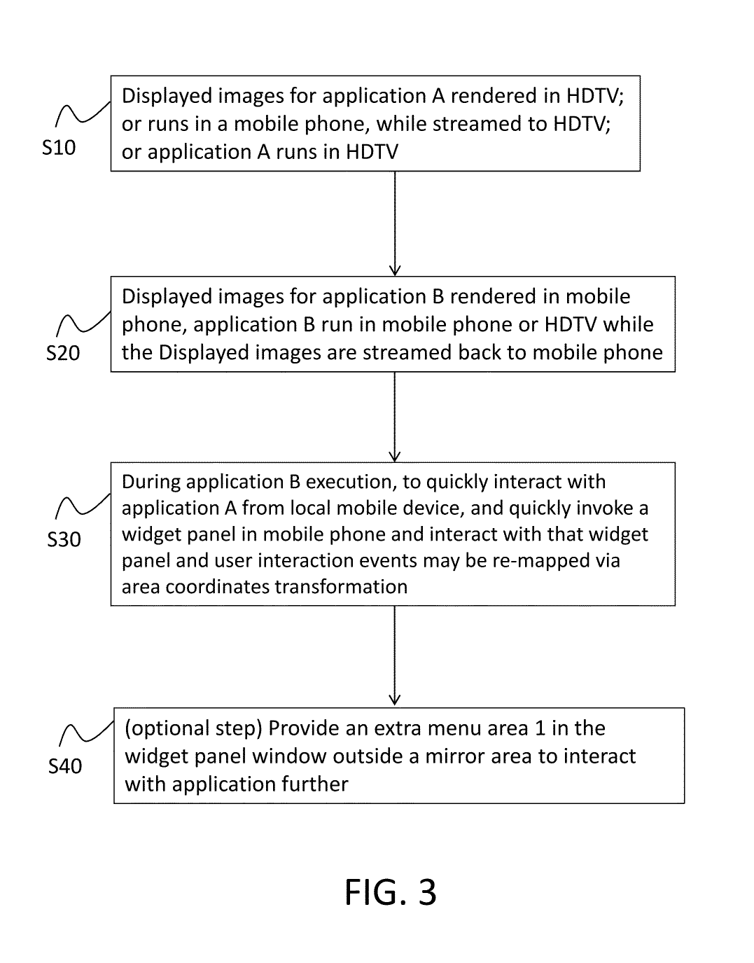

Referring to FIG. 3, a first embodiment of an implementation for invoking and dismissing a thumbnail control method in which display images are rendered and multiple applications are run on multiple electronic devices which are connected together, where user interface and interactions can be performed on any one device, while media images can be rendered on a screen of any one device, is described in the following steps:

Step S10: Displayed images for an application A are rendered in a remote HDTV; the application A can run in a local mobile phone device, while the displayed content is streamed to the remote HDTV; or the application A itself can run_in the remote device side such as, a set-top box or a smart TV.

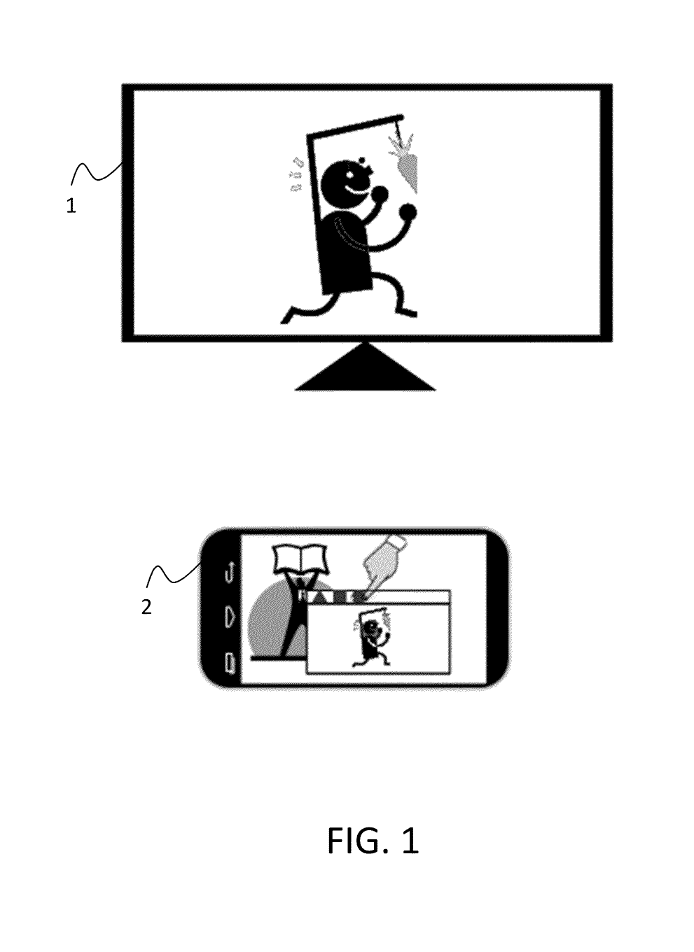

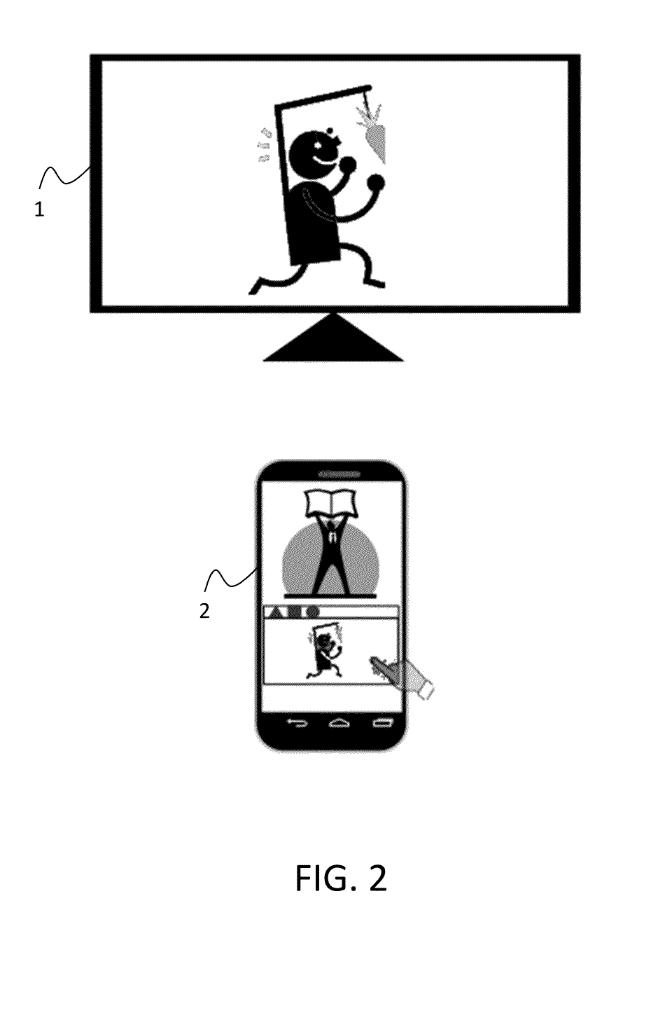

Step S20: Displayed images for an application B can be rendered in the screen of the local mobile phone device under a landscape orientation (see FIG. 1) or a portrait orientation (see FIG. 2); the application B can run in the mobile phone device directly or run in the remote device (such as, i.e. a set-top box or a smart TV) while the displayed images are streamed back to the screen of the local mobile phone device.

Step S30: During the application B's execution, a user can invoke the operation on the application A, so as to achieve a quick interaction with the application A, thus the user can quickly invoke a widget panel (which can be invoked via a system gesture, for example) in the screen of the local mobile phone. This widget contains a mirrored area that mirrors or replicates the displayed content of the entire display screen of the remote device within that “mirrored area” (typically the whole or one selected rectangular area on the display of the remote device is resized to a local window area with stretch on the content), and the user can interact with that widget panel in the local mobile phone, and the user interaction events (the touch events) occurring inside the “mirrored area” of the widget may be re-mapped per various screen resolutions between the screen of the local mobile phone and the screen of the remote display device, and to be sent to the application A for processing. More generally, the mirroring process of a pair of specified local area and remote area can be any predefined 2-D area to area coordinates transformation (typically linear translations) and the visual effects on the contents, mathematically speaking.

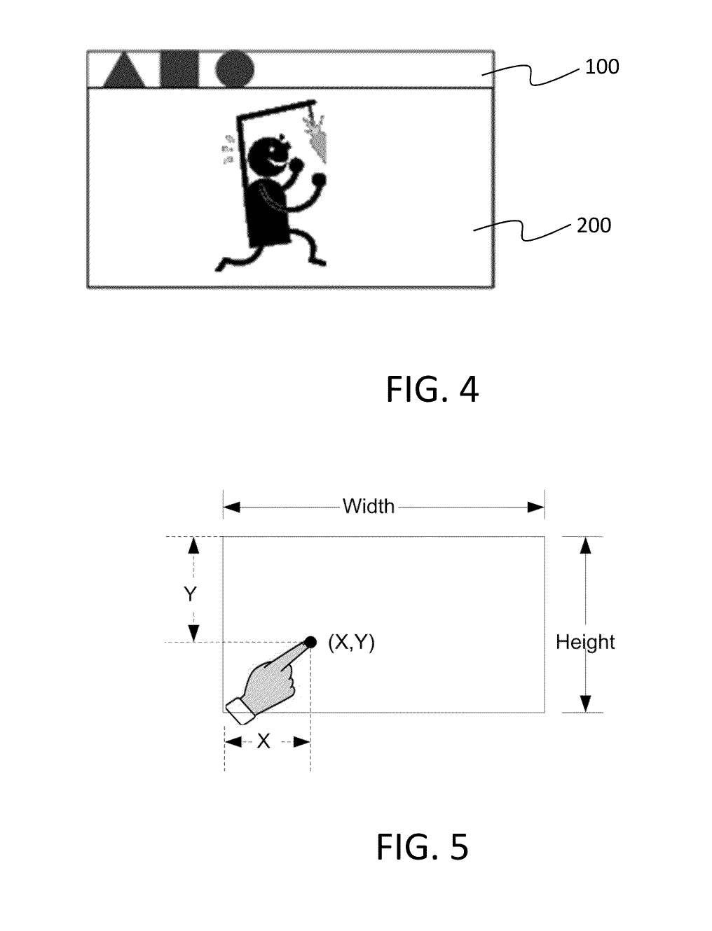

Step S40: (this is an optional step) Referring to FIG. 4, an extra menu area 100 found in the widget panel window disposed outside a mirror area 200 to interact with the application further, typically for the interactive events which is not triggered by touch, can be provided. For example, the extra menu area 100 in the widget panel window is to close or turn off the application A, to issue a “back” command to return to the application A (please be noted that if the user clicks the original “back” menu button in the local mobile phone, such “back” menu button click action command is issued to the application B instead), so as to re-launch the application A in the remote device etc. This menu area 100 can be treated as a system menu area to interact with the application A and when the user operates in the mirror area 200, it appears as if the user is operating directly in the remote HDTV. The menu area 100 can also include one or more functional buttons to trigger the adjustments on the “mirroring” parameters such as the mirrored area size and the position on the local screen, and the zoom in/out of the selected remote display area etc.

In the aforementioned thumbnail control implementation method embodiment, the mirror area 200 is not a static thumbnail snapshot, but a real-time mirroring of rendered display images at the remote device, or in other words, the mirror area 200 provides a live streaming of a plurality of video thumbnail image captures. The mirror area 200 does not have to contain the whole image capture of the screen of the remote device, but can also be just part of the screen of the remote device. In actual implementation, one button can be defined in the menu area 100, and once the user clicks that button defined in the menu area 100, a user mode can be entered by the user in which the user can select a particular desired rectangular area to be mapped to the local electronic device—which allows easier interaction in that desired rectangular area, especially when the local mirror area window is much smaller than the remote device, thus it may be difficult to accurately touch certain areas that are too small if the full larger screen was mirrored to the smaller screen of the local device.

The user can quickly dismiss the widget activity so that he can continue working in the application B in the local electronic device. In one of the possible implementation embodiments of the thumbnail control method, when the widget window is displayed, it will not allow the user to interact with other applications other than that particular widget window content, and in such implementation situation, any touch by the user in areas outside the widget window can dismiss the widget activity; and in other implementation embodiment, it allows the user to interact with both the widget window content (if the touch takes place inside the widget window) and other applications (if the touch had been taken place outside the widget window), the dismiss command can be issued via a command button located in the menu area 100.

In the above implementation embodiments for the thumbnail control method, the thumbnail control mode activity is always invoked in the electronic device which possesses user interaction capability. And it can be treated as a mirrored application of the original application A that is rendered in the remote electronic device. Once the activity is invoked, it will remap the touch events occurring in its mirrored region and sent to the application A for processing—thus as being perceived from the application A's point of view, the user interaction occurs on itself directly.

Touch Event Mapping:

In this embodiment, referring to the thumbnail control method, the touch events mapping can be illustrated as follow: the mapping is performed between the source area and the destination area via the coordinate transformation to ensure that the touch event sensed in one area can be mapped to another area. And there can be various algorithms or methods to implement the coordinate transformation such as, for example, a) as shown in FIG. 5, linear mapping to ensure a Width (X) and a Height (Y) maintains the same Width/Height ratio when re-mapped between two rectangle areas; b) the mirror area 200 can have a convex effect so that the center region of the image area can be larger than the outer region of the image area so that the user can touch specific points located in the center region more accurately than the outer regions thereof.

After the touch event mapping, for any touch event that has occurred inside the mirror area 200 of the widget panel, the touch position is determined and calculated so that it is mapped to the relative position of the rendering area of the application A, and it does not have to mirror the entire rendering area of the application A, since it can also mirror just part of the rendering area of the application A. For any touch event, the sensing information is detected and sent to the application A directly.

If the application A and the application B are running in the same electronic device, the display content mirroring, user interaction remapping and insertion can be conducted via across process communication method; if the application A and the application B are running in multiple electronic devices at the same time, there should be a physical data connection established between the multiple electronic devices, so as to allow for display content streaming and user touch event exchanges between the multiple electronic devices.

Generic Remote Control Method:

Another method to allow for additional user interaction is to treat the mobile phone as an external user interaction peripheral device of the HDTV, for extending the user interaction/interface capability of the HDTV itself—similar to that of a mouse or a touch pad, etc. Below describes some possible implementation embodiments under this method of the present disclosure.

Mouse/Track Pad Operating Mode:

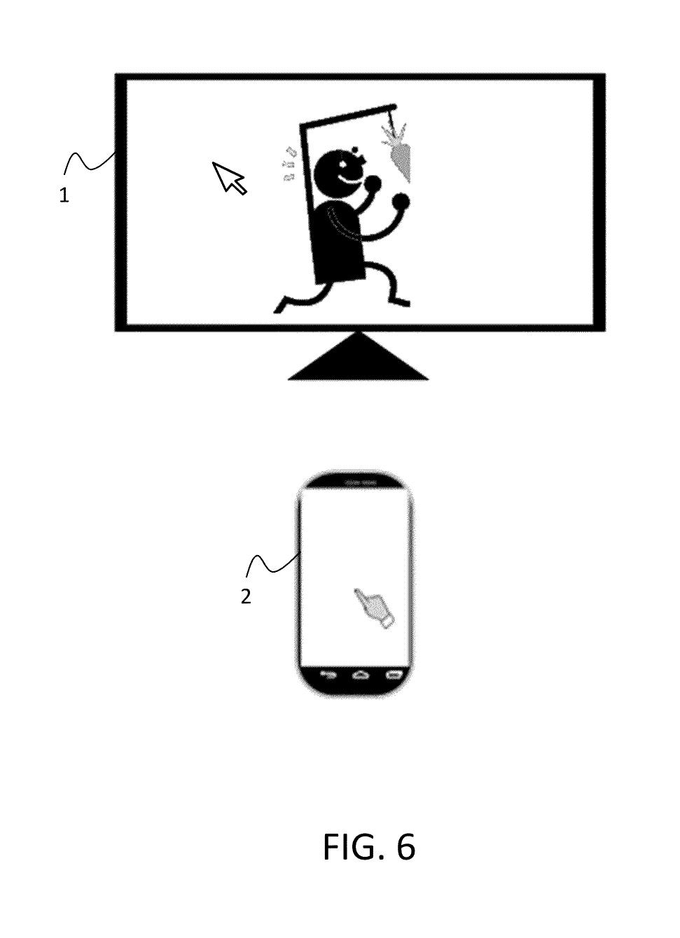

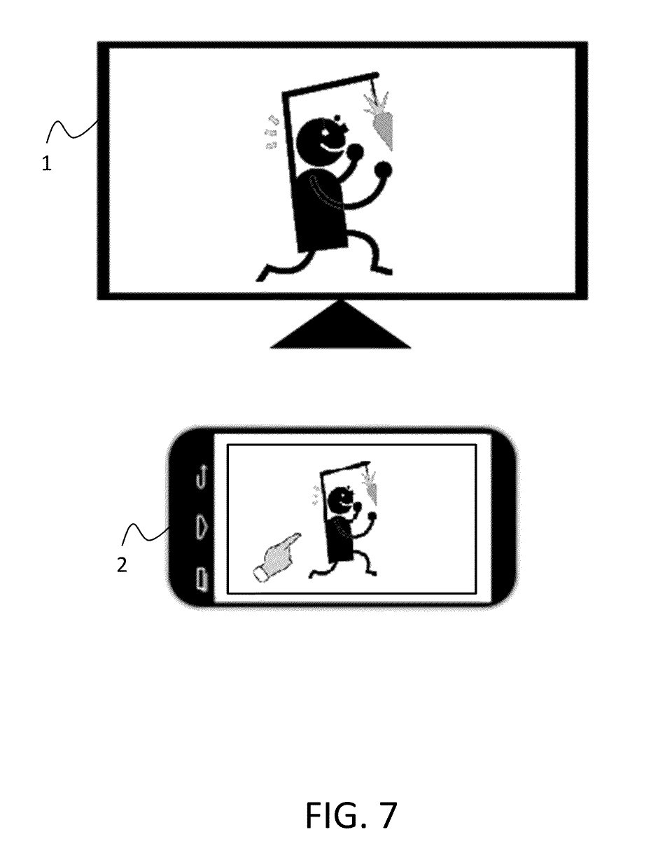

Referring to FIG. 6, when operating under a mouse/track pad operating mode under the generic remote control method, the mobile phone is turned into a mouse/trackpad device, and an application B is launched in a local mobile phone which behaves like a traditional trackpad device. The touch events that are occurring in the local mobile phone are transcoded to one or more trackpad events by the application B and the trackpad event are recognized as a low level event to the operating system environment under which an application A is rendered or shown on a HDTV. Therefore, the end result is that it looks as if the user is using one trackpad to interact with and control the application A shown in the HDTV. In the above mouse/trackpad operating mode embodiment, the application A and the application B do not have to be running in the same electronic device. In a usage scenario where they are running in two electronic devices, certain physical data connection or link needs to be established between these two devices so that the trackpad event can be communicated across the connection, and then to be injected to the operating system (OS) environment that the application A is running under. The operating system (OS) for mobile phone can be Apple iOS, Google Android, Samsung Bada, Blackberry OS, Windows Phone, Linux, etc. . . . . The operating system (OS) for smart TV or HDTV can be Apple iOS, Google Android, Samsung Bada, Blackberry OS, Windows Phone, Linux, etc.

Touch Screen Operating Mode:

In another embodiment under the generic remote control method of present disclosure, a touch screen operating mode, similar as the mouse operating mode, is provided. The only difference for this embodiment is that the user interface event is a touch event instead. Due to the various resolution sizes, the position needs to be remapped when being injected to the application A's execution environment. The re-mapping mechanism for this operating mode is the same as that found in the Thumbnail Control mode. And in the touch screen operating mode, the application B can also try to display a mirrored image of the application A in real time so that the user can capture the accurate position of as being displayed on the mobile phone.

Enhanced Touch Screen Operating Mode:

The previously described two operating modes have been implemented in existing embodiments and they are described herein for serving as the basis to describe the enhanced touch screen operation mode here which provides a new embodiment. In another embodiment under the generic remote control method of present disclosure, an enhanced touch screen operating mode is further provided. Today most of the mobile electronic devices are most suitable for touch-based operations instead of mouse or track-pad based operations; however, when a user tries to interact with any application when being displayed on the HDTV, there lacks a touch-based peripheral for control of the HOW while being used alongside the HDTV.

In “Mouse/trackpad operating mode”, the user can use a mobile phone to simulate a mouse; which shows a mouse pointer in the HDTV to guide user operation, while the mouse-based screen operation is not that common for many modern mobile device applications, which are touch-based operation instead.

In “Touch screen operating mode”, the user can use a mobile phone to simulate the touch panel device, thus now the user's finger is sliding on top of the mobile phone touch screen instead of the HDTV screen, which makes it difficult to capture the accurate position unless the user is looking at the mobile phone screen and at the same time, there is mirrored image being displayed in the mobile phone. In other words, if the user keeps looking at the screen of the HDTV only, there lacks a way to indicate at where the user's fingers should be placed since the user cannot see his fingers anymore.

Under the enhanced touch screen operating mode, the problems of the aforementioned first and second implementations are resolved by combining the advantages of both of the mouse and touch based implementations, so as to allow the finger position displayed in the remote device, such as the mouse's pointer, while using touch-based operation, assuming that the application A is the one that is rendered in the TV screen and the application B is the one that provides a user interface (UI) in the local mobile phone screen to allow the user to interact with the application A.

Finger Position Visual Hint Generation Method:

In one of the implementations, application B needs to manipulate both screens, namely the mobile phone screen and the TV screen, it provides the UI to allow the user to gain operation; and in the TV device screen, it needs to display the position of the finger placement when the user is interacting from the mobile phone's touch screen to provide user-friendly intuitive feedback. Due to the screen size variance or differences exist between the mobile phone and the TV, the touch position remapping is required, as previously described in the Thumbnail Control mode operation. In an implementation scenario where the TV is connected to the mobile phone directly (either via mHL/HDMI cable or WIFI connection), or in other words. the application A runs in the same device as that of application B, the application B itself can try to generate the finger indicator image and to render to the TV directly. And in another implementation scenario where the TV is connected to other electronic device other than a mobile phone, in other words, the application A runs in a different device other than the one where application B runs, the application B needs to find a way to communicate with that other electronic device so that the finger indicator image can be shown timely and accurately. Usually an utility will run in the same OS environment as application A and communicates with application B to retrieve necessary information regarding where to display the finger indicator image, which finger mode is etc, and this utility can then generate and display the proper finger indicator images in the screen to help the user to operate application A. And in a typical implementation, the finger indicator image is displayed in the remote electronic device in a separate overlay layer for better performance. In other implementation, it's also possible that there is one utility runs in the same device as application A resides and this utility will communicate with application B to draw the Finger Position Visual Hint image accordingly, based on the touch position captured in application B.

Normal Mode:

In enhanced touchscreen operating mode, there is a normal mode of operation for the interconnected multiple devices, and while operating in the normal mode, whenever there is a touch operation which occurs in the “touch” area of the application B, the finger position indicator is always displayed in the TV, meanwhile the touch events are issued directly to the application A. And when operating in the normal mode, the application B can also display the mirrored content of the application A in its operation window to allow for easier position capturing.

Hovering Mode:

In enhanced touchscreen operating mode there is a hovering mode of operation for the interconnected multiple devices, and while operating in the hovering mode, the finger movement or up/down gesture events are not issued to the application itself, but instead the position of finger placement is captured, and the finger indicator image is displayed in the TV accordingly. And when the user exits the hovering mode of operation, the touch event starts to issue to the application A. Below are several illustrative examples of this embodiment.

Some typical implementation methods to enter into and exit from the hovering mode include:
a) Define a hover area 10, and treat the first finger touch point in that area as entering a hovering mode and when that finger is lifted up (please be noted that the finger doesn't have to remain in the hover area 10 when being lifted up), it is recognized as being exiting hovering mode; or
b) Define a hover area 10, and treat the double finger tapping event in that area as entering hovering mode, and the single finger tapping event in that area as exiting the hovering mode.

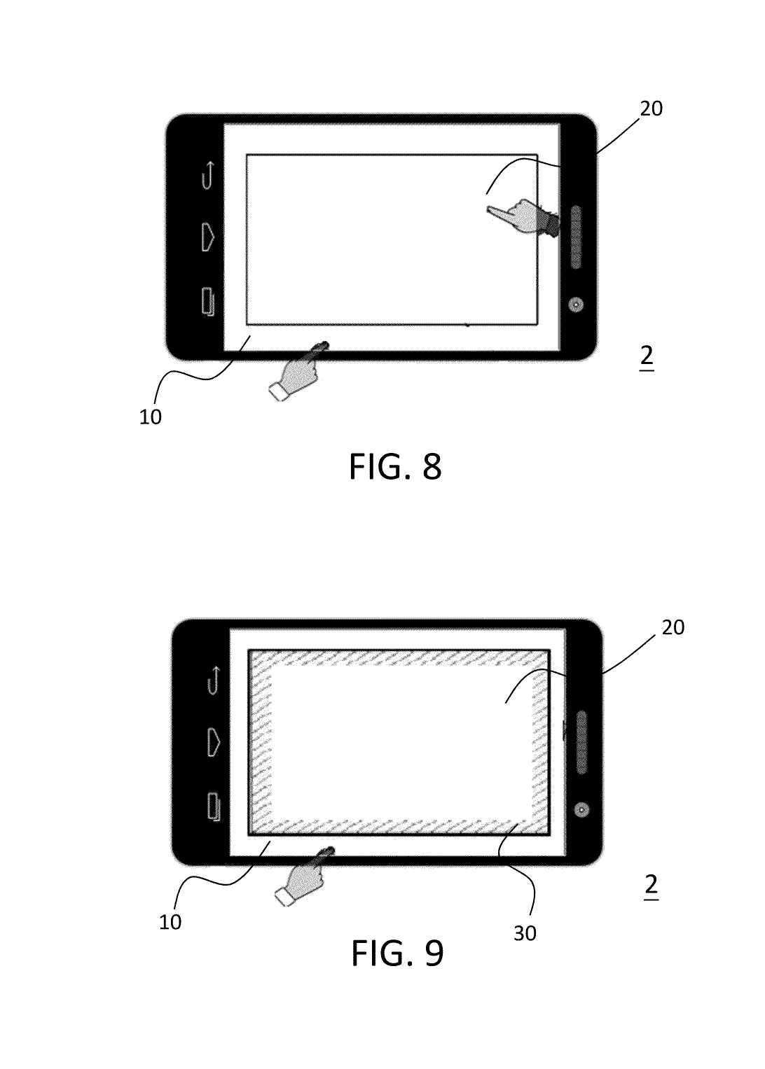

Referring to FIG. 8, when operating in the hovering mode, the finger movement occurring in a touch area 20 means that only the finger position indicator is shown in the remote device while no actual touch event is sent to the application A. And when the user releases the finger in the hover area 10, the hovering mode is exited and upon this time, the touch event is issued immediately.

An exemplary embodiment of the hovering mode is provided as follow: the user has moved his finger to the right position, and upon exiting the hovering mode, it looks like the user has issued a touch depress event in that position and this touch depress event is issued to the application A directly for processing. And it appears that in the hovering mode, the user is operating a mouse to move the mouse pointer (although the position mapping is not same as the mouse) around in the TV screen, and upon exiting the hovering mode, the user clicks the mouse button.

Referring to FIG. 9, another exemplary embodiment of the hovering mode is provided as follow: Meanwhile, one isolation area to avoid accidental miss-operation between the hover area 10 and the touch area 20 can be defined. And when the finger is swiping across the hover area 10 and the isolation area, it will be treated as being acting on the hover area 10, and when the finger is swiping across the touch area 20 and the isolation area, it can be treated as acting on the touch area 20. And upon the finger swiping across the touch area 20 and the isolation area, there can even be some reminder indicator provided to the user, such as, for example:
a) Device starts to vibrating
b) An “out of bound” reminder message to be displayed in the adjacency of “across” area

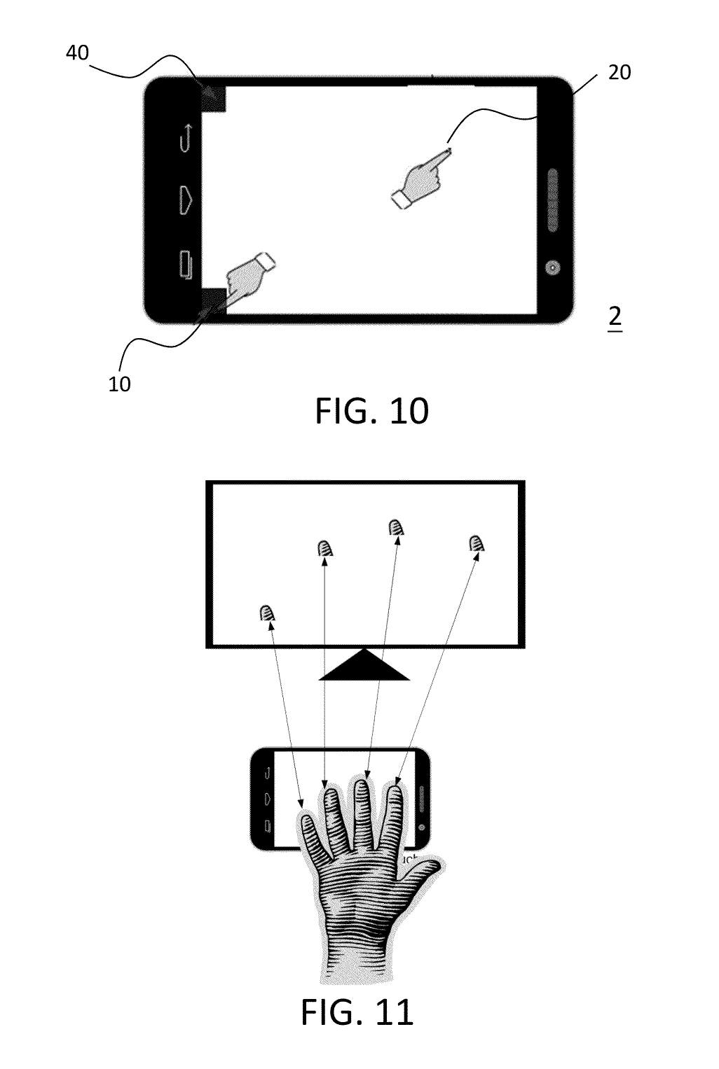

FIG. 10 shows an example in which the hover area is the entire outer edge frame region, and the hover area can also be a relatively small area in one corner if only one can easily enter and exit the hovering mode.

Yet another exemplary embodiment of the hovering mode is provided as follow: Multiple functional areas can be further defined to serve other different purposes other than entering and exiting the hovering mode. For example, the left-bottom corner can be defined as the hover area and the left-top corner can be defined as the “full screen” area to show/hide the local controls. In short, such special purpose functional modes such as for entering and exiting the hovering mode can and should be achieved easily and without interrupting the normal touch operation.

Air Mode Indicator Method:

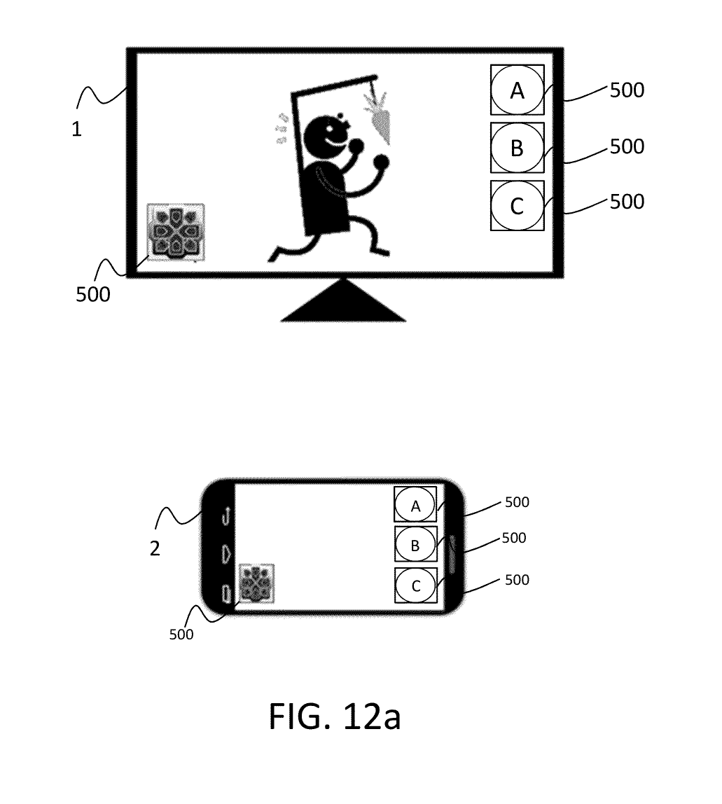

In another embodiment, there is an air mode indicator method provided to detect the finger position of a user even when his finger is hovering in the air at above an electronic device, the application B can also generate the corresponding finger indicator images per each detected finger gesture position and displays those finger indicator images in the remote device, which will help to guide the user to facilitate more intuitive further actual user interactions in the application B. FIG. 11 shows an embodiment of the air mode indicator method, in which there can also be various manipulations regarding the finger images displayed in the remote electronic device which can be impacted by various factors such as the distance from the touch screen. For example, when the fingers are still at a particular distance that is far away from the touch screen, the finger indicator images can be visibly seen as a semi-transparent image having a light color or as an finger indicator image having deeper transparency setting, and when the distance of the finger is brought closer to the touch screen, the finger indicator image becomes of a deeper color or the transparency becomes less noticeable or pronounced, such described types of image manipulations and changes can further assist the user to operate the electronic device. Regarding the method as to how to detect the exact finger position in the air is outside the scope of this disclosure since it is assumed that there is conventional method available to person skilled in the related art to easily collect the position information as to when the fingers are in the air.

Region Enhancement Mode:

When operating under a region enhancement mode, the user can pre-define certain areas in the remote electronic device, and to allow these pre-defined certain areas to have their respective layouts resized, reconfigured (including ZOOM operation capability) and mirrored in the mobile phone device; meanwhile the touch events that have occurred in the mapped areas in the mobile phone will be remapped and sent to the application A that is rendered in the TV.

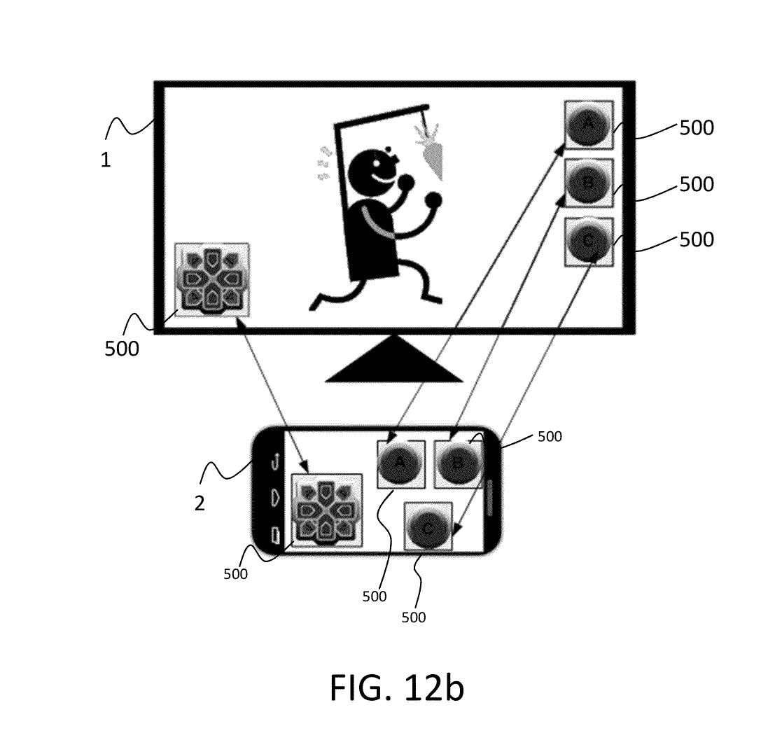

As shown in FIG. 12a, the mirrored content found in a plurality of interested designated areas 500 from the TV without having its layout being resized or reconfigured (including ZOOM operation); since the interested designated areas 500 are rather small in area as visibly shown in the mobile phone, it is difficult for the user to operate by finger gesture touching capability alone. FIG. 12b illustrates another embodiment through the use of resizing and reconfiguration of the interested designated areas 500 in the mobile phone by enlarging specifically those interested designated areas (including ZOOM) 500. And with such layout reconfiguration and resizing for the interested designated areas 500, it's much easier for the user to operate and control the application A displayed on the TV through the touch capability of the mobile phone.

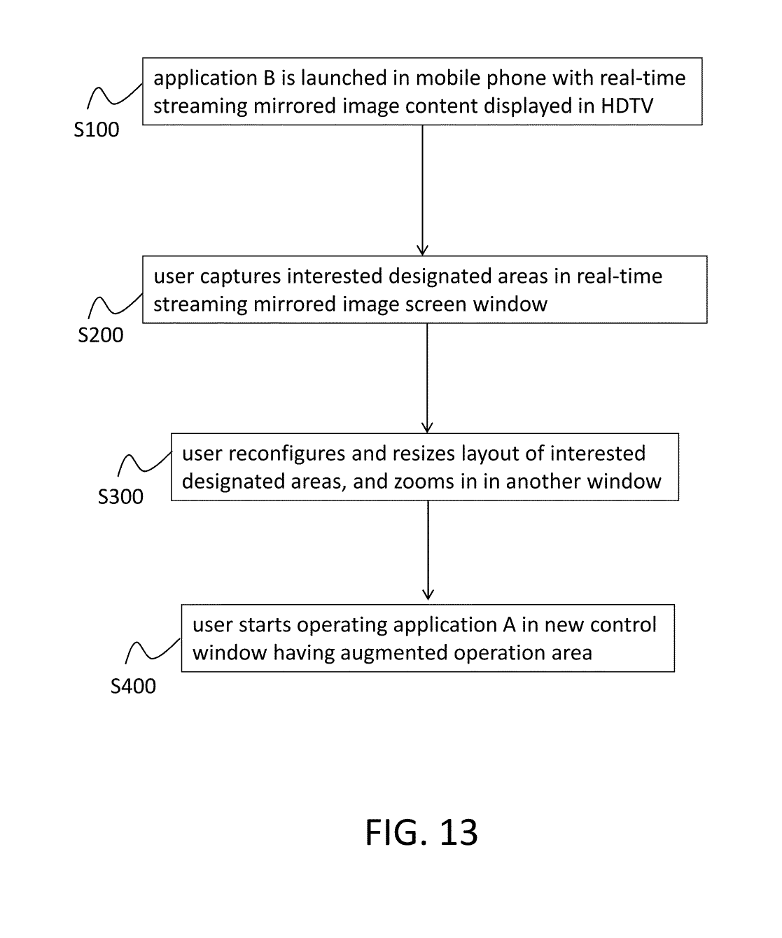

There can be an example usage application found in the mobile phone to ease the interested area selection and layout reconfiguration. FIG. 13 shows a preferred embodiment of the corresponding method, comprising of the following steps. Step S100: The application B is launched in the mobile phone with a real-time streaming mirrored image content displayed in the screen of a remotely connected HDTV. Step S200: A user captures one or more interested designated areas in the real-time streaming mirrored image screen window. Step S300: The user reconfigures and resizes the layout of the interested designated areas, and zooms in on the interested designated areas in another window. Step S400: The user starts operating the application A (which is rendered in the HDTV) in the new control window having the augmented operation area.

For each interested area re-mapping between the local electronic device (mobile phone) and the remote electronic device (HDTV), the touch events remapping mechanism is the same as the one described under the discussions for the thumbnail control mode herein. So that when the user operates in the reconfigured layout regions in the local electronic device, it looks as if the associated corresponding regions in the mirrored remote electronic device (HDTV) are operating accordingly.

Remapping Standard Skin Method:

In other alternative embodiments as found for gaming consoles, sometimes a full mapping between the two areas does not have to be ensured. And there may only need to be able to recognize certain user keyboard events which can be translated to normal gaming console events such as LEFT, RIGHT, UP, DOWN etc. And in such situation, the mapped two regions do not have to contain the same or decorated contents. For example, certain standard skins can be pre-defined—such as the standard game console skins to help create the region mapping. The following is an implementation embodiment. One can pre-define certain standard game console skins (i.e. four direction joystick pad, eight direction joystick pad, 360 degree round pad, round button etc.) and allow the user to easily re-map the standard skin to the actual control components in the remote electronic device (HDTV). And during the mapping operation, the user can pick up one standard component in the local electronic device, then move it around the screen to ensure the standard component can be mapped to the actual control components via a simple resizing or rotation operation. The captured mapped area will be treated as a source area; and later on, the user can resize the layout of the standard component in the local electronic device. And any touch event occurring in the standard component will then be mapped to the source area of the application A accordingly, which will trigger the relevant events properly.

Power Saving Mode:

In a power saving mode, when the local electronic device is used as an extended console to interact with the remote screen of the remote electronic device, there is no need to maintain the original backlighting or even keep continuously rendering the image to the screen of the local electronic device, since it can also have the option to enter into various power saving modes such as by performing one or more of the following:
1) decrease the backlight;
2) turning off the power to the LCD display so that the LCD display only displays a black screen.

Meanwhile, to escape from the power saving mode, the user can easily restore to the original working state by various methods, such as by clicking one pre-defined area (the right-top area for example) or by clicking the power button etc.

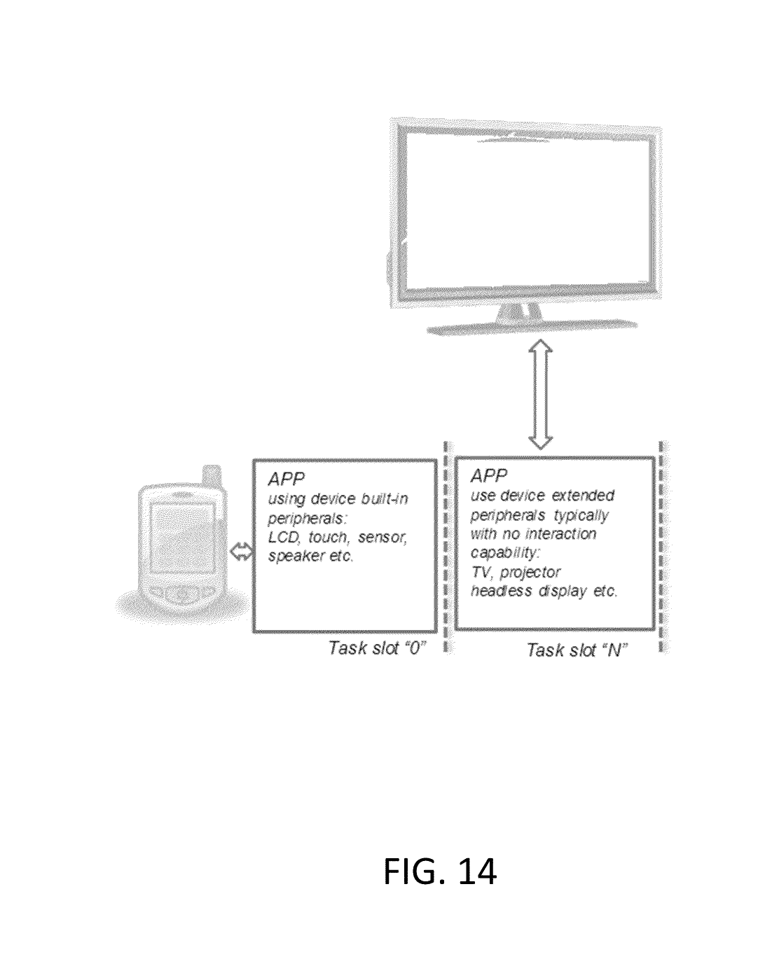

Referring to FIG. 14, a generic architecture for a system for providing user interface capability to a remote device without user interface capability through connection to a local device configured with user interface capability so as to form an integrated multiple-device multimedia system is described as follow. A first application and a second application is provided for the remote device and the local device, respectively. The second application in the local device is used to interact with the first application that renders in the remote device and the first application can be any application that runs in its own OS environment. The local device may be, for example, a mobile phone, an electronic tablet device, a notebook computer, a wireless touch device, or an electronic touch device. The remote device may be, for example a desktop computer, an HDTV, a smart TV, a notebook computer, a projector TV, or a HD projector. An operating system (OS) for the local device may be, for example, Apple iOS, Google Android, Samsung Bada, Blackberry OS, Windows Phone, or Linux, and the operating system (OS) for the remote device may be, for example, Apple iOS, Google Android, Samsung Bada, Blackberry OS, Windows Phone, or Linux. During usage when running in the local and remote devices, the physical data connection is established between the two devices, so that one or more user interaction event is communicated across the connection, and then to be injected to the operating system (OS) environment that the first application is operating under.

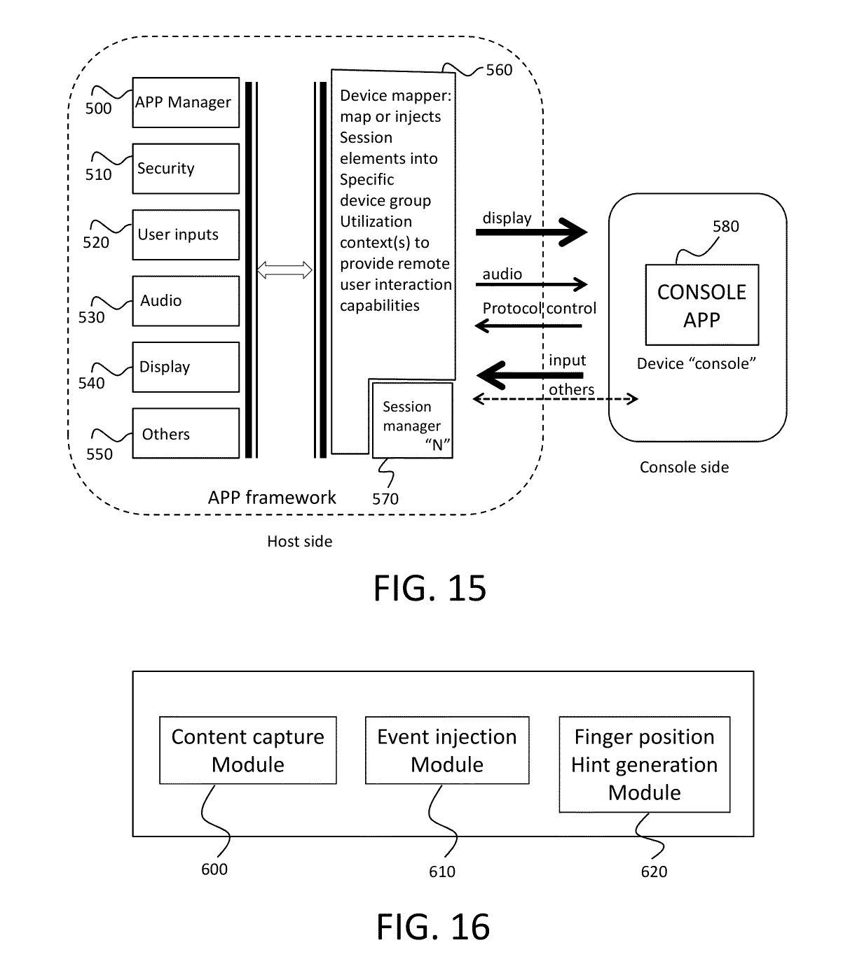

As shown in FIG. 15, a basic software architecture of the system for providing user interface capability to a remote device without user interface capability through connection to a local device configured with user interface capability so as to form an integrated multiple-device multimedia system may be of a typical client-server paradigm which includes a client “console”, a server “host” with certain extensions in the OS application framework and the communication protocol. Both the client and the server, are not necessarily configured on different physical devices. A host is the software environment where the application runs. It can be attached to a variety of devices, such as for example, a set-top-box, a tablet, a phone or a home application cloud. The application frame work on the host includes an app manager 500, a security module 510, an user inputs module 520, an audio module 530, a display module 540, and other functional module 550, a device mapper 560, a session manager 570. In the console, there is a console app 580.

The OS application framework needs to provide for the capabilities for the following functional modules as shown in FIG. 16:
a) Content capture module
   A content capture module 600 is provided to “mirror” a total or partial content of various specified devices (typically for display and audio) to a communication session. The term “Mirroring” used herein generally refers to a transformation from a serial of areas in the original content to the serial of areas in the data stream which can be decoded later in the console to present in a serial of areas.
   To generate the real-time interactive live thumbnail, the display and audio source need to be selected and encoded. The display source is a rectangle clip-window to the real display content of selection. Modifications in the GFX composition and window manager is required to provide the capability (for certain authorized system component) to acquire the content for processing.
b) Event injection Module.
   An event injection module 610 is provided to inject the events such as input to the target application which is being spied upon.
   The injected events need to match the content being mirrored. For example, we can sniffer a partial rectangle area of the TV display then a coordinate transformation is required to map the touch position on the console to the sniffer area of the TV.
   Here are the some typical implementations for event injecting:
      1) using reflect driver in the kernel to emulate standard input devices and implement a filter in an operating system (OS) (such as, Android) Input service to identify the route;
      2) direct inject events into the application framework; OS input service and sensor service.
c) Finger Position Hint Generation Module
   A Finger Position Hint Generation module 620 is provided to improve the touch experience of the user especially when using the console blindly. There is a system component that listens to the touch events and hint control messages related certain session to show certain hint images on the target display of relationship. The hint can be images to indicate the finger positions, finger utilization mode etc.
      Please be noted, based on usage scenario, a host application framework implementation does not have to include all the abovementioned modules. For example, in alternative embodiments, the Finger Position Hint Generation module 620 may not be present. A console is defined herein in the instant disclosure as an application running on a handheld smart device such as a mobile phone.

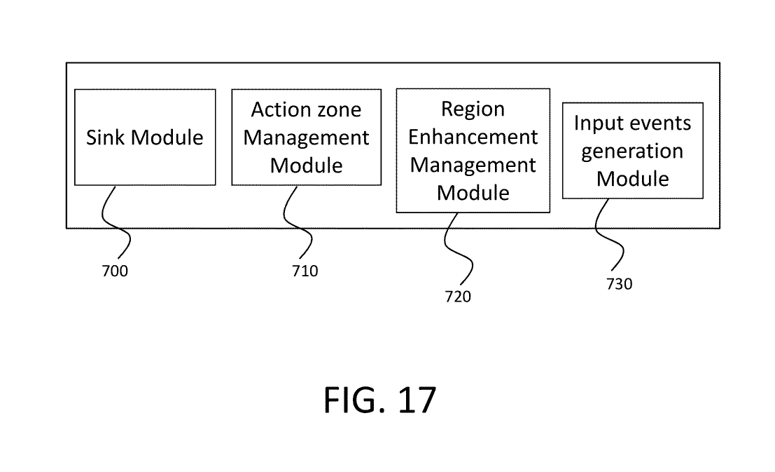

Referring to FIG. 17, the console app contains the following modules:
a) Sink module
   A sink module 700 is provided to receive streaming data to present the display and audio content to the user.
b) Input Events Generation Module
   An input events generation module 730 is provided to generate input events for touch, keypad, mouse, various types of sensors, and sending to the host for injection. A filter in the input stream sink is used to pick up the coordinate related input events such as touch events and perform a coordinate transformation to map the events correctly to the associated window before being sent to the target application. Linear transformation is the most commonly used one; non-linear can be used to facilitate better user interactions such as lens effect to make the center portion of the viewing area become larger and easier for finger control.
c) Action Zone Management Module
   An action zone management module 710 is provided to manage the various operating modes for switching, initializing, and tracking. For example, the action zone management module 720 provides functionalities to switch between the trackpad mode and the touch screen mode; and in touch screen mode, to enter hovering mode and to leave hovering mode.
d) Region Enhancement Management Module
   A region enhancement management module 720 is provided to support the region enhancement mode operation as described previously herein. And the region enhancement management module 720 can allow user to enter into an editor mode, for example, to pick up the interested area to be remapped on the host and then to be re-layout in the console.
      Please be noted, based on usage scenario, a console implementation does not have to include all of the abovementioned modules (a-d). For example, for a Thumbnail Control Method implementation, only the sink module and the input events generation module would be required for usage.

It will be apparent to those skilled in the art that various modifications and variations can be made to the structure of the invention without departing from the scope or spirit of the invention. In view of the foregoing, it is intended that the present invention cover modifications and variations of this invention provided they fall within the scope of the following claims and their equivalents.

What is claimed is:

1. A system for providing user interface capability to an electronic device without user interface capability through connection to another electronic device configured with user interface capability so as to form an integrated multiple-device multimedia display system, comprising:
a local device and a remote device, the local device is a mobile phone, an electronic tablet device, a notebook computer, a wireless touch device, or an electronic touch device, the remote device is an electronic tablet device, a desktop computer, an HDTV, a smart TV, a notebook computer, a projector TV, or a HD projector;
a first application and a second application, the second application in the local device is configured to interact with the first application that renders in the remote device and the first application is any application that runs in the corresponding OS environment and renders in the remote device, the second application is capable of running in either the local device or running in a different device other than the local device);
an operator system for the local device, and an operating system for the remote device, the operating system (OS) for the local device is Apple iOS, Google Android, Samsung Bada, Blackberry OS, Windows Phone, or Linux; the operating system (OS) for the remote device is Apple iOS, Google Android, Samsung Bada, Blackberry OS, Windows Phone, or Linux; and
a physical data connection, wherein during usage when the first application and the second application are running in different devices, the physical data connection is established between the two devices thereof, so that one or more touch pad event is communicated across the connection, and then to be injected to the operating system (OS) environment that the first application is operating under.

2. A method for providing intuitive user interaction for sharing among multiple devices, comprising:
connecting a remote device without intuitive user interaction to a local device configured with intuitive user interaction;
providing a thumbnail control scheme in which display images of the remote device screen are rendered in the screen of the local device
providing a generic remote control scheme in which the local device is acting as an external user interaction peripheral device of the remote device; and
providing a region enhancement mode by having a plurality of areas pre-defined in the remote device, and having the pre-defined areas' respective layouts resized, reconfigured and mirrored in the local device, while the touch events that have occurred in the mapped areas in the local device are remapped and sent to an application that is rendered in the remote device.

3. The method for providing intuitive user interaction for sharing among multiple devices as claimed in claim 2, wherein an application is run in a local device having fully range of touch-enabled user interaction capability, while one or more application content is rendered in a remote device without having full range of touch-enabled user interaction capability.

4. The method for providing intuitive user interaction for sharing among multiple devices as claimed in claim 2, wherein the thumbnail control scheme comprising the steps of:
rendering one or more displayed images for a first application which is shown in a remote HDTV by streaming while the first application runs in a local device or rendering one or more displayed images for a first application in a remote HDTV and the second application runs in the remote HDTV;
rendering one or more displayed images for a second application in the screen of the local device; the second application runs in the local device directly or runs in the remote device while the displayed images are streamed back to the screen of the local device;
interacting with the first application by the user during executing of the second application, by invoking a widget panel in the screen of the local device and operating on the widget panel window directly;
providing a mirrored area in the widget to mirror the displayed content of the entire or part of the display screen of the remote device,
interacting with the widget panel in the local device, and
remapping the user interaction events occurring inside the mirrored area of the widget per screen resolutions between the screens of the local device and of the remote device, respectively, and sending to the first application for processing.

5. The method for providing intuitive user interaction for sharing among multiple devices as claimed in claim 4, wherein the mirrored area is a real-time mirroring of rendered display images at the remote device, the mirrored area is a whole image capture of the screen of the remote device or a part of the screen of the remote device.

6. The method for providing intuitive user interaction for sharing among multiple devices as claimed in claim 2, wherein the thumbnail control scheme further comprising the steps of:
providing an extra menu area in the widget panel window disposed outside the mirror area to interact with the first application for the interactive events not triggered by touch in the mirrored window,
turning off the first application by the extra menu area in the widget panel window;
issuing a back command to the first application
re-launching the first application in the remote device to fit its execution context; and
triggering the adjustments on the mirrored area size, the position on the screen of the local device, and the zoom in/out of the selected display area of the remote device by one or more functional buttons.

7. The method for providing intuitive user interaction for sharing among multiple devices as claimed in claim 6, wherein at least one button is defined in the menu area, and upon the user clicking on the button, a user mode is entered by the user in which the user selects a particular desired rectangular area to be mapped to the local electronic device.

8. The method for providing intuitive user interaction for sharing among multiple devices as claimed in claim 2, wherein when operating in the thumbnail control scheme, and upon displaying of the widget window, the user is able to quickly interact with the first application that renders in the remote device by operating in the widget window.

9. The method for providing intuitive user interaction for sharing among multiple devices as claimed in claim 8, wherein a thumbnail control scheme activity is always invoked in the electronic device which possesses user interaction capability, and once the thumbnail control scheme activity is invoked, the touch events occurring in its mirrored region will be remapped and sent to the first application for processing; the touch events remapping is performed between the source area and the destination area via the coordinate transformation.

10. The method for providing intuitive user interaction for sharing among multiple devices as claimed in claim 9, wherein a plurality of algorithms to implement the coordinate transformation comprising a linear mapping to ensure a Width (X) and a Height (Y) maintains the same width/height ratio when re-mapped between two rectangle areas; or other algorithm under which the mirrored area is to have a convex effect so that the center region of the image area is larger than the outer region of the image area.

11. The method for providing intuitive user interaction for sharing among multiple devices as claimed in claim 2, wherein when providing the generic remote control scheme, the local device is a mobile phone, and the remote device is a HDTV, and the mobile phone is treated as an external user interaction peripheral device of the HDTV.

12. The method for providing intuitive user interaction for sharing among multiple devices as claimed in claim 11, wherein when providing the generic remote control scheme, and operating under a mouse/trackpad operating mode comprising of performing the steps below to turn the mobile phone into a mouse/trackpad device:
launching a second application in the mobile device behaving as a track pad device;
transcoding the touch events occurring in the mobile device to one or more trackpad events by the second application; and
sending the trackpad event as a low level event to the operating system environment under which a first application is running and rendering content on the HDTV, while the first application and the second application do not have to be running in the same electronic device.

13. The method for providing intuitive user interaction for sharing among multiple devices as claimed in claim 11, wherein when providing the generic remote control scheme, and operating under a touch screen operating mode, the user interface event is a touch event, and when operating under an enhanced touch screen operating mode, other than sending the touch event into the operating system where the first application runs, one of the utility in the operating system also generates the finger position hint images per the relevant finger position caught in the mobile device which is similar as the mouse pointer shown in the mouse operating mode.

14. The method for providing intuitive user interaction for sharing among multiple devices as claimed in claim 13, wherein when operating under the enhanced touch screen operating mode and a combined mouse and touch based implementation, comprising of performing the steps of:
displaying the finger position in the remote device in the form of a mouse pointer while using touch-based operation;
rendering the first application in the HDTV screen; and
providing a user interface (UI) in the mobile phone screen by the second application to allow the user to interact with the first application.

15. The method for providing intuitive user interaction for sharing among multiple devices as claimed in claim 13, wherein when operating under the enhanced touch screen operating mode and a finger position visual hint generation scheme, the HDTV is connected to the mobile phone directly, the second application is to generate the finger indicator images and to render to the HDTV directly, or the second application communicates with one utility from the execution environment of the first application and the one utility from the execution environment of the first application is to generate the finger indicator images and to render to the HDTV directly.

16. The method for providing intuitive user interaction for sharing among multiple devices as claimed in claim 15, wherein when operating under a normal mode of operation for the interconnected multiple devices, whenever there is a touch operation occurring in the touch area of the second application, the finger position indicator is displayed in the HDTV, meanwhile the touch events are issued directly to the first application for processing and the second application is capable of displaying the mirrored content of the first application in its operation window.

17. The method for providing intuitive user interaction for sharing among multiple devices as claimed in claim 15, wherein when operating under a hovering mode of operation for the interconnected multiple devices, where the finger movement or up/down gesture events are not issued to the application itself, but instead the position of finger placement is captured, and the finger indicator image is displayed in the TV accordingly, and when the user exits the hovering mode of operation, the touch event starts to issue to the first application.

18. The method for providing intuitive user interaction for sharing among multiple devices as claimed in claim 17, wherein entering into and exiting from the hovering mode comprising of the steps of: defining one hover area, and treating the first finger touch point in that area as entering the hovering mode and considering the lifting of the finger as being exiting the hovering mode, or treating the double finger tapping event in that area as entering the hovering mode, and considering the single finger tapping event in that area as exiting the hovering mode; upon exiting the hovering mode, a touch depress event is issued to the first application directly for processing, and the user is appeared to be operating a mouse to move the mouse pointer around in the TV screen when being under the hovering mode, and clicking on the mouse button to issue the corresponding actual touch depress event upon existing the hovering mode.

19. The method for providing intuitive user interaction for sharing among multiple devices as claimed in claim 17, further comprising of defining an isolation area between the hover area and the touch area, wherein when the finger is swiping across the hover area and the isolation area, the finger will be treated as being acting on the hover area, and when the finger is swiping across the touch area and the isolation area, the finger is treated as acting on the touch area; upon the finger swiping across the touch area and the isolation area, a reminder indictor in the form of vibrating of the local device or displaying of a reminder message in the adjacent areas is provided.

20. The method for providing intuitive user interaction for sharing among multiple devices as claimed in claim 2, further comprising an air mode indicator scheme to detect the finger position of a user even when his finger is hovering in the air at above an electronic device, the second application is to generate the corresponding finger indicator images per each detected finger gesture position and displays the finger indicator images in the remote device, wherein when the fingers are still at a particular distance that is far away from the touch screen, the finger indicator images is visibly seen as a semi-transparent image having a light color or as an finger indicator image having deeper transparency setting, and when the distance of the finger is brought closer to the touch screen, the finger indicator image becomes of a deeper color or the transparency becomes less noticeable.

21. The method for providing intuitive user interaction for sharing among multiple devices as claimed in claim 2, wherein the region enhancement mode comprising the steps of:
launching a second application in the local device with a real-time streaming mirrored image content displayed in the remote device;
capturing one or more interested designated areas in the real-time streaming mirrored image screen window;
reconfiguring and resizing the layout of the one or more interested designated areas, and zooming in on the interested designated areas in another window; and
initiating operating of the first application in the new control window having the augmented operation area.

22. The method for providing intuitive user interaction for sharing among multiple devices as claimed in claim 2, further providing a remapping standard skin scheme by pre-defining one or more standard game console skins and remapping the standard skin to the actual control components in the remote device, during the mapping operation, selecting one standard component in the local device, and moving it around the screen to ensure the standard component is mapped to the actual control components via a simple resizing or rotation operation.

23. The method for providing intuitive user interaction for sharing among multiple devices as claimed in claim 2, further providing a power saving mode by using the local electronic device as an extended console when interacting with the remote electronic device, to thereby decreasing the original backlighting or rendering the image in a discontinuous manner to the screen of the local electronic device, and turning off the power to the LCD display of both the local and remote electronic devices.
